(19) United States
(12) Patent Application Publication
(10) Pub. No.: US 2016/0103621 A1
(43) Pub. Date: Apr. 14, 2016

(54) Multi-Block Data Storage Using Data Compression

(71) Applicant: Seagate Technology LLC, Cupertino, CA (US)

(72) Inventors: GieSeo Park, Yongin-si (KR); GyuTaek Kim, Yongin-si (KR); YoungHo Kim, Yongin-si (KR); DongHyuk Shin, Yongin-si (KR)

(73) Assignee: Seagate Technology LLC

(21) Appl. No.: 14/511,639

(22) Filed: Oct. 10, 2014

(51) Int. Cl. G06F 3/06; G06F 12/08

(52) U.S. Cl. CPC G06F 3/0619; G06F 12/0875; G06F 3/0655; G06F 3/0679; G06F 2212/452; G06F 2206/1014

(57) ABSTRACT

Method and apparatus for data storage using data compression techniques. In some embodiments, a data recording medium has a recording surface with a plurality of concentric tracks accessible using a moveable data read/write transducer. A cache memory temporarily stores data during transfer operations with the data recording medium. A controller is configured to, responsive to receipt of input write data, retrieve from the data recording medium to the cache memory a selected multi-block data set associated with the input write data, use the received input data to update the retrieved multi-block data set, compress the updated retrieved multi-block data set to generate a compressed data set, and write the compressed data set to a selected band of adjacent tracks on the data recording surface. A portion of the compressed data set is generated during movement of the data read/write transducer to the selected band of adjacent tracks.

### SUMMARY

Various embodiments of the present disclosure are generally directed to data recording media using a data compression technique.

In accordance with some embodiments, a rotatable data storage medium has a data recording surface on which is defined a plurality of concentric tracks. The concentric tracks are accessible using a moveable data read/write transducer. A cache memory is adapted to temporarily store data during transfer operations with the data recording medium. Responsive to receipt of input write data, a controller is configured to retrieve from the data recording medium to the cache memory a selected multi-block data set associated with the input write data, use the received input data to update the retrieved multi-block data set, compress the updated retrieved multi-block data set to generate a compressed data set, and write the compressed data set to a selected band of adjacent tracks on the data recording surface, a portion of the compressed data set generated during movement of the data read/write transducer to the selected band of adjacent tracks.

In other embodiments, a method includes accessing a plurality of concentric tracks using a moveable data read/write transducer, the concentric tracks arranged as shingled magnetic recording (SMR) tracks in a selected band on a rotatable data recording medium. Received input write data are stored in a cache memory. Responsive to receipt of the received input write data, a multi-block data set is transferred from the selected band to the cache memory. The received input data are used to update the transferred multi-block data set in the cache memory. The updated transferred multi-block data set is compressed to generate a compressed data set, and the compressed data set is written to the selected band. A portion of the compressed data set is generated during movement of the data read/write transducer to the selected band and prior to the writing of the compressed data set thereto.

In other embodiments, a data storage device has a rotatable data recording medium with shingled magnetic recording (SMR) tracks arranged into concentric bands accessible using a moveable data read/write transducer. A cache memory is adapted to temporarily store data during transfer operations with the data recording medium. A controller is configured to, responsive to receipt of input write data, transfer a selected multi-block data set from a selected band to the cache memory, use the received input write data to update the transferred multi-block data set, compress the updated retrieved multi-block data set to generate a compressed data set, and write the compressed data set to the selected band on the data recording surface, a portion of the compressed data generated during movement of the data read/write transducer to the selected band.

These and other features and aspects which characterize various embodiments of the present invention can be understood in view of the following detailed discussion and the accompanying drawings.

### BRIEF DESCRIPTION OF THE DRAWINGS

FIG. 1 is a functional representation of a data storage device in accordance with various embodiments of the present disclosure.

FIG. 2 is a functional representation of another data storage device corresponding to the device of FIG. 1.

FIG. 3 depicts a storage medium adapted for shingled magnetic recording (SMR).

FIG. 4 shows an arrangement of shingled (partially overlapping) data tracks.

FIG. 5 illustrates bands of shingled data tracks.

FIG. 6 depicts band compression timeline.

FIG. 7 shows band compression and decompression in parallel with loading and writing bands.

FIG. 8 illustrates a band compression outcome.

FIG. 9 depicts a cache memory system.

FIG. 10 shows media cache compression.

FIG. 11 is a flow chart for a data recording routine using a data compression technique in accordance with various embodiments.

### DETAILED DESCRIPTION

The present disclosure generally relates to the storage of data on a data storage medium using a specially configured data compression technique.

A conventional hard disc drive (HDD) has one or more rotatable data recording surfaces that are accessed by a corresponding array of moveable data read/write heads (transducers). The basic unit of writing data to a conventional HDD is a single sector that is of selected length, such as 512 bytes or 4096 bytes (4K). The sector is a subdivision of a track on the HDD so that each track has multiple sectors.

Recently developed HDD recording systems employ other writing techniques to enhance writing efficiencies. These techniques include shingled magnetic recording (SMR), TDMR (two-dimensional magnetic recording), and MSR (multi-sensor recording) applications. SMR generally involves partially overlapping previously written tracks with new adjacent tracks to decrease track pitch (distances between the center lines of adjacent tracks). TDMR generally involves concurrently writing data sets to multiple adjacent tracks. MSR generally involves using multiple sensors to read and/or write data to one or more adjacent tracks.

The use of each of these and other types of writing techniques may alter the basic writing unit used by an HDD. For example, the basic writing unit for an SMR HDD is often defined as a band of multiple tracks that are written and read as a unit. It will be appreciated that a band is substantially larger than a single sector in terms of overall data capacity.

In order to write updated data to a a selected band in an SMR HDD, data from the entire band or a portion thereof may be transferred to a local memory. The transferred data are updated, and then the updated data are rewritten to the band. While SMR recording is operable to increase data storage capacity, data transfer rates in SMR HDDs can suffer as compared to conventional HDDs, particularly as the volume of data read from and rewritten to each band increases. Similar inefficiencies can be observed in TDMR and MSR applications.

Accordingly, various embodiments are generally directed to an apparatus and method for transferring data in a data storage device. As explained below, some embodiments provide a data storage device with a rotatable data recording medium having a data recording surface on which is defined a plurality of concentric tracks accessible using a moveable data read/write transducer. A cache memory of the device is adapted to temporarily store data during transfer operations with the data recording medium.

A controller is configured to, responsive to receipt of input write data, retrieve from the data recording medium to the cache memory a selected multi-block data set associated with the input write data, use the received input data to update the retrieved multi-block data set, compress the updated retrieved multi-block data set to generate a compressed data set, and write the compressed data set to a selected band of adjacent tracks on the data recording surface, a portion of the compressed data set generated during movement of the data read/write transducer to the selected band of adjacent tracks.

In this way, data are compressed before the data are written so that latency time required to write or read the data can be reduced, and therefore improve read and/or write performance of the device. It has been found in some cases that the overall performance of the device with the band compression technique may actually be improved in comparison to a device using a conventional sector (e.g., 512, bytes, 4K bytes, etc.) as the basic unit of writing data.

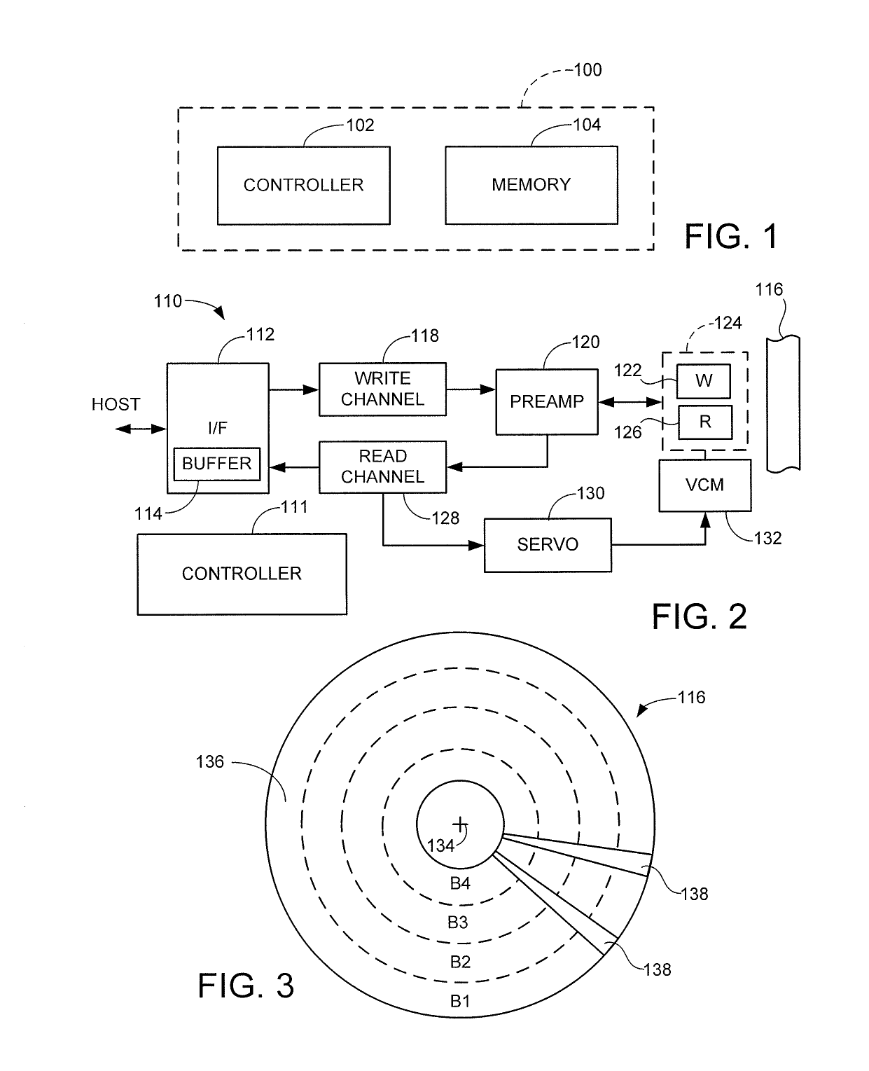

These and other features of various embodiments disclosed herein can be understood beginning with a review of FIG. 1 which provides a functional block representation of a data storage device 100. The device 100 includes a controller 102 and a memory 104. The controller 102 can take a variety of forms such as a hardware based control circuit or a general purpose programmable processor having suitable programming to provide top level control for the device.

The memory 104 can take a variety of forms and is contemplated to employ shingled magnetic recording (SMR), heat assisted magnetic recording (HAMR), two dimensional magnetic recording (TDMR), multi-sensor reading (MSR), and/or other forms of enhanced writing techniques that provide large, multi-track write units. Multi-sector sets of data that use outer code parity values to provide error detection code (EDC) protection for the entire set of data are also envisioned. To provide concrete examples, SMR medium will be used in this disclosure, but a variety of media forms are contemplated.

FIG. 2 is a functional block diagram for a data storage device 110 that corresponds to the device 100 of FIG. 1 in accordance with some embodiments. The data storage device 110 is characterized for purposes of the present disclosure as a hard disc drive (HDD) that employs perpendicular magnetic recording to store data from a host device (not separately shown). Such is merely exemplary and is not limiting.

The device 110 in FIG. 2 includes a top level controller 111 that may be realized in hardware or firmware. An interface circuit (I/F) 112 communicates with the host device and includes a data buffer 114 to temporarily store data pending transfer between the host device and a rotatable perpendicular data recording medium 116.

A write channel 118 operates to encode input write data from the host to provide a serialized data stream to a preamplifier/driver (preamp) 120. The preamp 120 provides a sequence of write currents to a perpendicular magnetic write element (W) 122 of a data transducer 124 to write data to the medium 116.

During a readback operation, readback signals are transduced by a magneto-resistive (MR) read element (R) 126 of the data transducer 124. The transduced signals are supplied to the preamp 120. The preamp 120 conditions and amplifies the readback signals and provides the same to a read channel 128. The read channel 128 applies signal processing techniques to recover the originally stored data to the buffer 114 pending subsequent transfer to the host.

During both read and write operations, specially configured servo positioning data provided to the medium 116 are transduced by the read element 126 and, after demodulation by a portion of the read channel 128, are supplied to a servo control circuit 130. The servo control circuit 130 provides positional control signals to a voice coil motor (VCM) 132 coupled to the data transducer 124 to position the respective write and read elements 122, 126 adjacent various data tracks defined on the medium 116.

FIG. 3 depicts an arrangement of the medium 116 of FIG. 2 in accordance with some embodiments. The medium 116 is characterized as a perpendicular magnetic recording disc which is rotated at a selected rotational velocity by a spindle motor (not shown) about a central axis 134.

The data tracks are grouped together into a number of bands 136. Four such bands are illustrated in FIG. 3 and denoted as bands B1-4. While the bands B1-4 are shown as extending through the entire circumference of the medium 116, such is merely exemplary and not limiting. Any or all of the bands of the medium 116 may be substantially less than the entire circumference of the medium 116. Each band 136 comprises a grouping of concentric data tracks (not separately shown in FIG. 3). Those skilled in the art will appreciate that any number of bands, including hundreds or thousands (or more) of concentric bands, may be defined on each medium surface as desired.

While not limiting, the writing of data sets can be arranged so as to occur with different bands 136; that is, the bands 136 can be predefined or adaptively defined during operation, with each set of new data written successively to a new band. Previously written data may be moved to a new, different band 136 for data management purposes. Bands having a large number of successive access (read and/or write) operations may be rewritten in place or moved to a new location.

FIG. 3 further shows the medium 116 to have a number of servo wedges 138 which are arrayed in spaced apart fashion around the circumference of the medium 116, much like spokes of a wheel. While only two servo wedges 138 are depicted in FIG. 3, it will be appreciated that several hundred such wedges (or more) may be provisioned around the medium as desired. User data are written to sectors in the bands 136 in the area between adjacent pairs of the servo wedges 138. The servo wedges 138 provide the requisite servo positioning control data to the servo circuit 130 (FIG. 2) to facilitate precise positioning of the respective read and write elements over the respective bands 136.

The servo positioning information can take a variety of forms such as Gray code addresses, dibit (e.g., ABCD) servo patterns, etc. The servo data may be printed during disc manufacture, formed during servo writing (including through the use of a multi-disc writer, MDW), written by the device 110 during a self-servo writing operation, etc. Other forms and types of servo systems can be used.

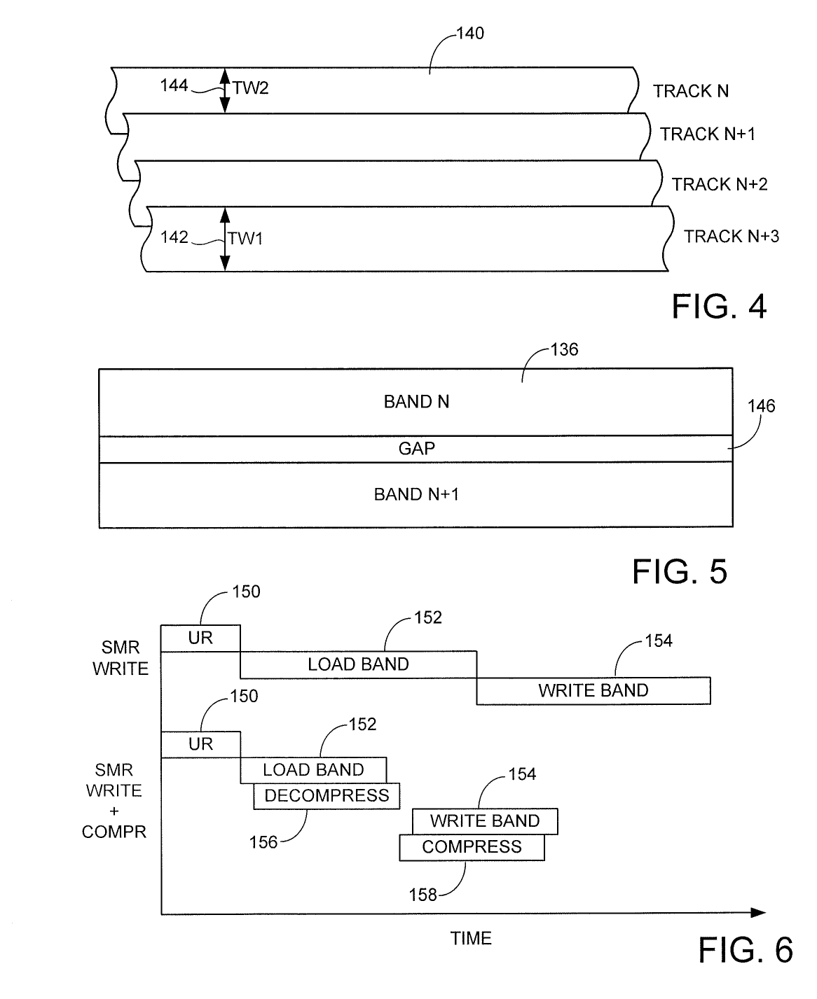

The tracks in each band 136 are shingled, or partially overlap, as generally illustrated in FIG. 4. More specifically, FIG. 4 shows a total of four shingled tracks 140, with individual track addresses arbitrarily identified as Track N to Track N+3. Track N is written first, followed successively by Track N+1, Track N+2 and Track N+3. Each successively written track 140 partially overlaps the previously written track. The last written track in the ban may be non-overlapped.

As initially written, each track has an initial track width TW1 denoted at 142, which corresponds to the effective magnetic field write width of the write element 122 (FIG. 2). Once shingled, each track has a final track width TW2 denoted at 144, which corresponds to the effective magnetic field sensor width of the read element 126 (FIG. 2). This enhances data density since generally, more tracks per unit of radial width on the media can be written. However, to update the tracks in a band, generally each of the tracks need to be read and then rewritten in the same sequence, since, for example, a write update to just track N+1 would tend to overwrite track N+2 and prevent recovery of the data thereon.

FIG. 5 is a general representation of two bands 136 made up of respective numbers of shingled tracks 140 from FIG. 4. The bands are arbitrarily denoted as Band N and Band N+1. Each band 136 can have the same total number of tracks 140, or can have different respective numbers of tracks and accordingly, different radial widths. The bands 136 can be predefined or defined on-the-fly as new write data are supplied by the host.

A gap 146 is shown between the respective bands 136 and represents a discontinuity boundary between one band to the next. A similar gap will generally be provided between each adjacent pair of bands on each media surface. The position and width of the gap 146 are controlled in a manner to be discussed below. It will be appreciated that the gap 146 may be treated as a separate element by the control system or may be incorporated into one or other of the adjacent bands. In at least some embodiments, the gap 146 is significantly narrower than a single effective track width (e.g., less than the TW2 width 144 in FIG. 4).

With these considerations in mind, the present disclosure may be characterized as managing a multi-block data set of the type that encompasses multiple tracks on a rotatable media (a “band”), where the data set is managed as a unit during read and write operations. Data are arranged into relatively large groups of data that are managed as a unit. Each group of data may constitute tens or hundreds of individually logically addressable sectors (e.g., LBAs). Group sizes may vary or may be maintained at a nominally constant size on the recording medium. Each group may be written to a band of adjacent tracks.

By using bands, there may be a performance to decrease experienced during data updates for data managed in bands. Generally, to update a portion of data previously written to a particular band, the contents of the entire band are recovered to local memory, those sectors (e.g., LBAs) within the band contents are updated, Outer code or other EDC are recalculated (as required), and the entire updated set of data is written to the recording medium, either in the same location or to a different location.

This type of multi-block data grew processing can induce a performance lag in comparison to the conventional HDD operations that replace an update data at the individual, i.e., LBA, level. This performance lag occurs because it takes time to access the existing data, update the data, and then rewrite the data to the media. The rotational latencies required to position the transducer(s) adjacent to the recording surface(s) of the recording medium are compounded as the size of the multi-block data group grows larger, and the bands encompass larger numbers of tracks.

FIG. 6 shows a graphical representation of SMR write with and without compression (compr). Generally, various embodiments of the present disclosure operate to compress data before the data is written to the SMR HDD so that the disc movement to write and/or access the data on the SMR HDD can be reduced. This reduces time to write and time to read the data, thus improving the overall performance of the SMR HDD.

In a conventional SMR write without compression, a user request (UR) is made to write data to the recording surface of the media. The processing of this user request is represented by block 150 in FIG. 6 and constitutes a first time interval. An existing data set from the associated band is loaded into a local memory during a second time interval, as indicated by block 152. The data set is updated and the updated data set is written back to the band during a third time interval, as indicated by block 154. The blocks 150, 152 and 154 generally occur sequentially in a non-overlapping fashion.

The SMR write update with compression operation in FIG. 6 includes additional decompression and compression blocks 156, 158. The user request requires processing as before at 150. The data are loaded at block 152 from the shingled band to the local memory and subjected to decompression at block 156, which occurs concurrently as the data are read from the media.

Because of the physical space savings provided by the compressed data on the media, fewer revolutions/total number of data sectors may require access, so that the loading operation may be shorter as shown in FIG. 6. Once the data are updated, the compression of the updated data begins in block 158 and continues during the writing of the data back to the band, block 154. The compression can commence and be carried out while the read/write transducer is being moved to the target track to write the data. In some cases, both the decompression of a first portion of the data can be carried out concurrently with the compression of a second portion of the data, so that blocks 156, 158 in FIG. 6 can be overlapping in time.

Thus, during the read/write process carried out on the SMR HDD, if the load band 152 is decompressed into a decompressed band 156 in a fourth time interval, and the write band 154 is compressed into a compressed band 158 in a fifth time interval, then the overall time to service the access request may be reduced.

By compressing the updated data, a smaller amounts of data and hence, a smaller physical footprint may be required to write the multi-block data group, e.g., the band, to the media. This smaller footprint results in fewer rotations of the media and fewer rotational latency intervals as the transducers are positioned adjacent the bands.

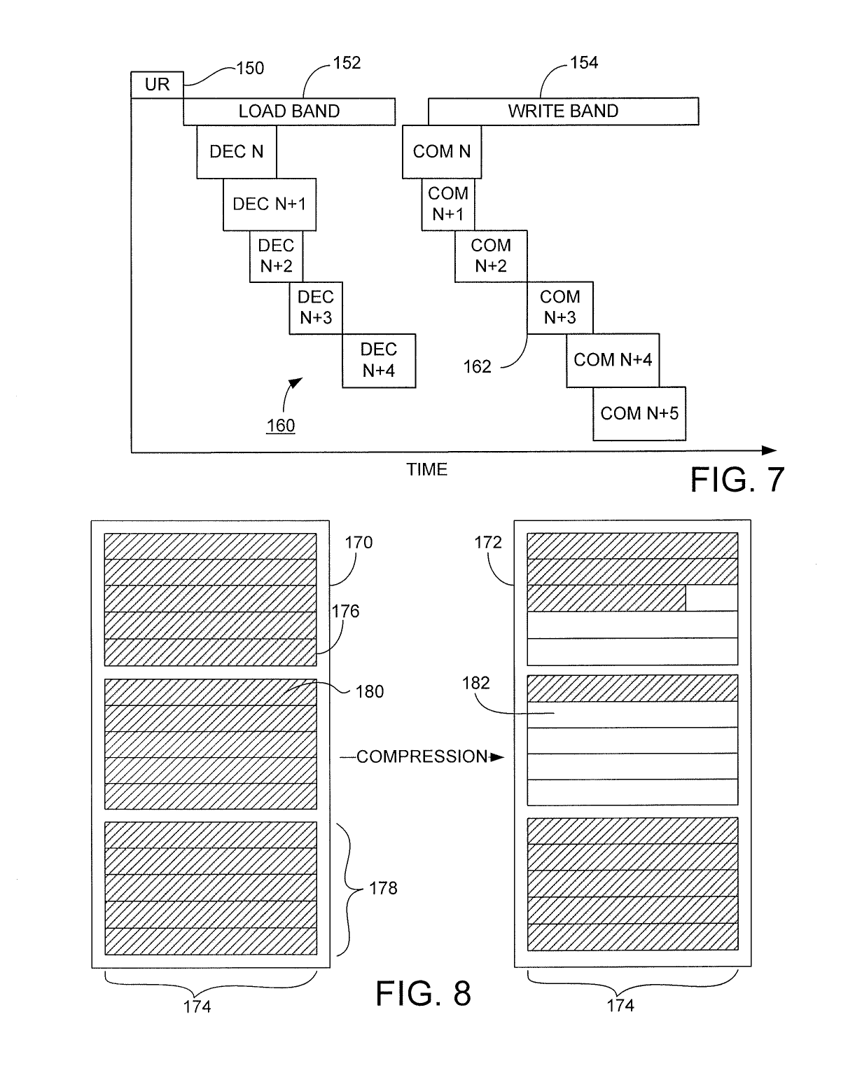

Although additional arithmetic operations may be needed to compress and decompress the band, the arithmetic operations may be processed in parallel with the read and write operations on the disc. As shown in FIG. 7, compressing processing can be carried out concurrently with the data writing operation, and the decompression processing can be carried out concurrently with the data reading operation, both of which may lead to further perform its improvements. A total of five decompressions 160, with individual decompressions arbitrarily identified as DEC N to Track N+4, are shown. A total of 6 compressions 162, with individual compressions arbitrarily identified as COM N to COM N+5, are shown. More or fewer decompressions and compressions may be performed. An equal or different number of compressions and decompressions may be performed on a given load band and write band.

Compression of the data may typically start after all decompression of the data has occurred, however compression of the data may start before the decompression has completed for the entire load band. Decompression of the data will typically start after at least a portion of the load band has been read. Different portions of the load band 152 may be decompressed at different intervals. More than one decompression may be occurring in the same interval of time. Different portions of the write band 154 may be compressed at different intervals. More than one compression may be occurring in the same interval of time. So although additional arithmetic operations may be needed to compress and decompress the band, the arithmetic operations may be processed in parallel with the read operations from and write operations to the media.

As a result of data compression and decompression, including parallel performance of same, the overall performance of the SMR HDD may improve, because the band compression technique is faster than the conditional technique used in the conventional HDD. The cost of calculation associated with the compression and decompression processes may occur, and more power and time may be needed accordingly. However the costs may be less than the performance and energy efficiency gained by reducing the energy and time necessary for the physical disc movement without the compression and decompression.

FIG. 8 illustrates a situation where data covered by a unit band 170 is compressed so that the physical movement to write and/or read the disc is reduced. The band unit 170 is shown as having sectors 174, tracks 176, and bands 178. The sectors 174 are shown to be of the same nominal size, but size of the sectors might vary. Although 3 bands of 5 track seats are shown, more or fewer bands and/or tracks are contemplated.

In order to fully write a conventional SMR band, disc movement covering the entire band unit is needed. However, if the compression technique of the present disclosure is applied, less disc movement may be necessary, for the band unit 172. Through the compression and decompression of the band, the time to write and/or read the band is reduced. The written sectors 180 are shown in crosshatch. The non-written sectors 182 are shown without a fill pattern. In the example shown, in the conventional SMR disc on the left, it takes time X for 15 revolutions of the disc to write the 15 tracks in the 3 bands, whereas it only takes time Y for only 9 revolutions of the disc to write the compressed data of the 9 tracks in the 3 bands using the compression technique disclosed. The time X taken to write 15 tracks over 15 revolutions of the disc will typically be greater than the time Y taken to write 9 tracks over 9 revolutions of the disc. Of course, there may be other than a one-to-one ratio between tracks written and revolutions of the disc.

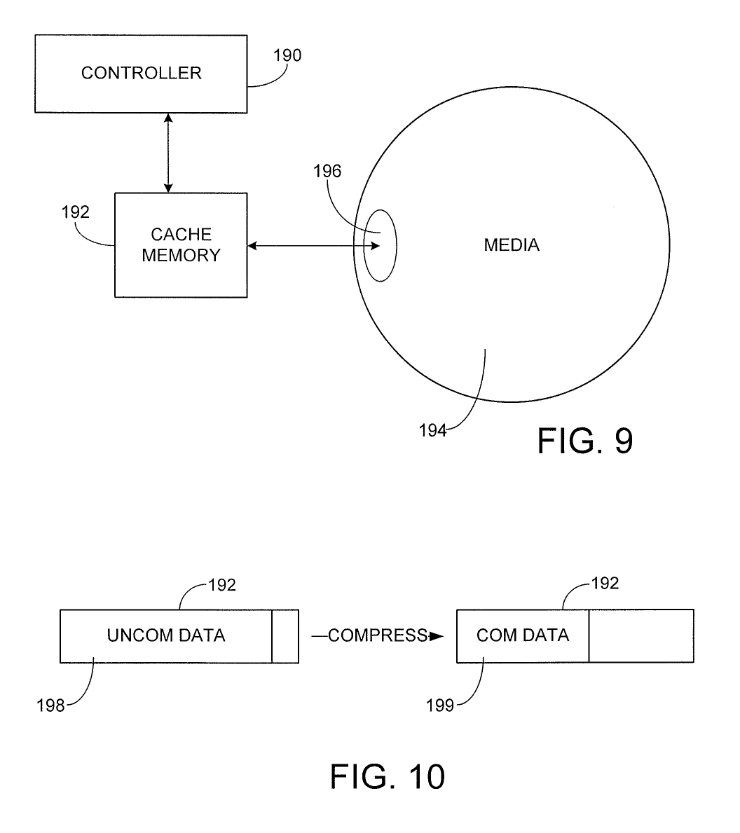

FIG. 9 illustrates an embodiment that includes use of a cache memory, also known herein as media cache, 192. A controller 190 controls input to the media cache 192. Input data are streamed to the media cache 192 before being transferred to a recording media 194. The data from the media cache 192 may be written in the band 196. The media cache 192 may be a nonvolatile cache memory in the form of flash memory, rewritable solid-state memory, a portion of the recording surface of the recording media by way of example and not limitation. Of course, the cache media 192 may be made of a combination of memory types.

The controller is configured to generate a compression ratio, which is total number of tracks in the selected band corresponding to the compression ratio as compared to how many tracks would be required if the data were not compressed.

During writeback processing, read performance may actually be increased by using the media cache 192 in comparison to a conventional HDD. If a host requests the data in the media cache 192, the media cache 192 can immediately provide the data without need to access the recording media 194 that will typically have a slower access time than the media cache 192. The data may be characterized as made a data, control data, POR data, user data, by way of example and not limitation.

FIG. 10 demonstrates that the data may be written to the cache memory 192 in an uncompressed format. The data is then compressed, and the compressed data is written to the media 194. The cache memory 192 may be configured to store compressed data (COM DATA) 199 and/or uncompressed data (UNCOM DATA) 198. The media cache 192 may be used to obtain better performance in write situations, such as random write situations. In addition, by compressing data in the media cache 192, there is room to write more data in the media cache 192.

Another embodiment involves power on recovery (POR) systems in which pending rate data and other system parameters are saved to a cache area, also known as scratch pad, in the event of a power down event. During subsequent POR, the data in the scratch pad are returned to the recording media. The data stored in the scratch pad for POR efforts can also be compressed to reduce POR time. For example, the SMR HDD may record random write data in media cache, and then use the random write data to update the band during idle time. For POR purposes, the data may be temporarily written to the scratch pad. The technique of compressing the scratch pad to reduce time in updating the band may reduce the possibility of incurring power loss and power recovery problems.

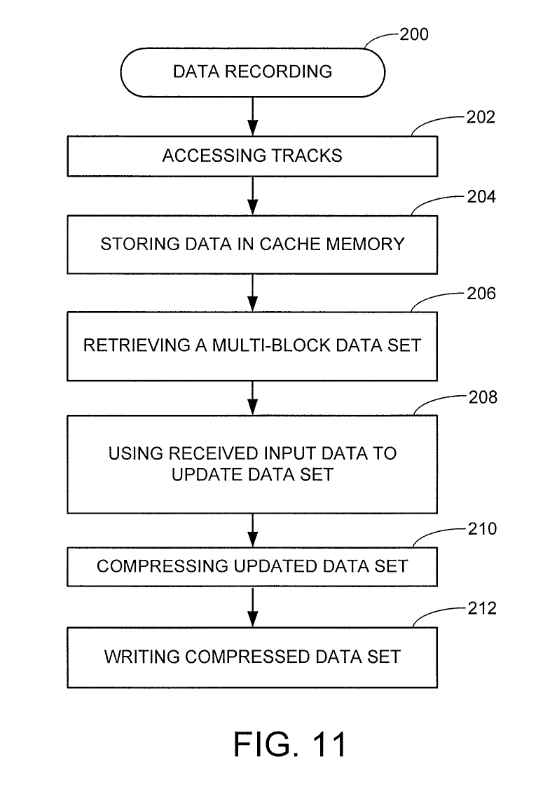

FIG. 11 is a flow chart for a shingled magnetic recording (SMR) routine 200 to illustrate the writing of data in accordance with the foregoing discussion. It will be contemplated for purposes of explanation that the routine is carried out by the device 110 of FIG. 2 to format bands of tracks as set forth earlier. Other routines can be used so that the various steps can be modified, omitted or carried out in a different ordering as desired.

Using a moveable data read/write transducer a plurality of concentric tracks is accessed at step 202. The plurality of concentric tracks may be defined on a data recording surface of a repeatable data recording medium. A cache memory may temporarily store data during transfer operations with the data recording medium at step 204.

Responsive to receipt of input rate data, a selected multi-block data set associated with the input rate data is retrieved from the data recording medium to the cache memory at step 206. The received input data is used to update the retrieved multi-block data set at step 208. The updated retrieved multi-block data set is compressed to generate a compressed data set at step 210.

The compressed data set is written to a selected band of adjacent tracks on the date or recording surface. A portion of the compressed data is generated during movement of the data read/write transducer to the selected band of adjacent tracks.

For purposes of the appended claims, references to shingled magnetic recording and the like will be understood consistent with the foregoing discussion as a sequential recording technique whereby successive tracks partially overlap previously written tracks in a selected order, and require rewriting in the same order rather than permitting the tracks to be written in any order as in conventional, non-shingled magnetic recording.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A data storage device comprising:
a rotatable data recording medium having a data recording surface on which is defined a plurality of concentric tracks accessible using a moveable data read/write transducer;
a cache memory adapted to temporarily store data during transfer operations with the data recording medium; and
a controller configured to, responsive to receipt of input write data, retrieve from the data recording medium to the cache memory a selected multi-block data set associated with the input write data, use the received input data to update the retrieved multi-block data set, compress the updated retrieved multi-block data set to generate a compressed data set, and write the compressed data set to a selected band of adjacent tracks on the data recording surface, a portion of the compressed data set generated during movement of the data read/write transducer to the selected band of adjacent tracks.

2. The data storage device of claim 1, in which the tracks in the selected band are characterized as shingled magnetic recording (SMR) tracks so that each successive track in the selected band partially overlaps each previously written immediately adjacent track, the multi-block data set retrieved from the selected band as compressed data, the controller further configured to decompress the multi-block data set.

3. The data storage device of claim 2, the controller further configured to decompress a first portion of the multi-block data set and concurrently compress a second portion of the multi-block data set.

4. The data storage device of claim 1, in which the controller is further configured to generate an outer code parity value to provide error detection and correction (EDC) capability for the compressed data set.

5. The data storage device of claim 1, in which the controller is further configured to generate an outer code parity value to provide error detection and correction (EDC) capability for the compressed data set, and the data read/write transducer has multi-sensor reading (MSR).

6. The data storage device of claim 1, in which the cache memory is a non-volatile cache memory in the form of flash memory.

7. The data storage device of claim 1, in which the cache memory is a rewritable solid state memory.

8. The data storage device of claim 1, in which the cache memory is a portion of the data recording surface.

9. The data storage device of claim 1, in which the data is characterized as user data with multiple blocks, each of the multiple blocks having an associated logical block address.

10. The data storage device of claim 1, in which the controller is further configured to generate a compression ratio, the total number of tracks in the selected band corresponding to the compression ratio as compared to how many tracks would be required if the data were not compressed.

11. A method comprising:
accessing a plurality of concentric tracks using a moveable data read/write transducer, the concentric tracks arranged as shingled magnetic recording (SMR) tracks in a selected band on a rotatable data recording medium;
storing received input data in a cache memory;
responsive to receipt of the input write data, transferring a multi-block data set from the selected band to the cache memory;
using the received input data to update the transferred multi-block data set in the cache memory;
compressing the updated transferred multi-block data set to generate a compressed data set; and
writing the compressed data set to the selected band, a portion of the compressed data set generated during movement of the data read/write transducer to the selected band and prior to the writing of the compressed data set thereto.

12. The method of claim 11, in which the compressed data set is an updated compressed data set, the multi-block data set retrieved from the selected band is an initial compressed data set, the method further comprising decompressing at least a portion of the initial compressed data set prior to the using step.

13. The method of claim 12, further comprising decompressing a portion of the initial compressed data set while concurrently compressing a portion of the updated compressed data set.

14. The method of claim 11, in which the cache memory is a rewritable solid state memory.

15. The method of claim 11, in which the cache memory is a portion of the data recording surface.

16. The method of claim 11, in which the data is characterized as user data with multiple blocks each having an associated logical address.

17. The method of claim 11, further comprising generating a compression ratio, the total number of tracks in the selected band corresponding to the compression ratio as compared to how many tracks would be required if the data were not compressed.

18. A data storage device comprising:
a rotatable data recording medium having shingled magnetic recording (SMR) tracks arranged into concentric bands accessible using a moveable data read/write transducer;
a cache memory adapted to temporarily store data during transfer operations with the data recording medium; and
a controller configured to, responsive to receipt of input write data, transfer a selected multi-block data set from a selected band to the cache memory, use the received input write data to update the transferred multi-block data set, compress the updated retrieved multi-block data set to generate a compressed data set, and write the compressed data set to the selected band on the data recording surface, a portion of the compressed data generated during movement of the data read/write transducer to the selected band.

19. The apparatus of claim 18, the selected band comprising at least one track from which at least a portion of the multi-block data set was retrieved and to which at least a portion of the compressed data set is written.

20. The apparatus of claim 18, the compressed data set characterized as an updated compressed data set, the transferred selected multi-block data set characterized as an initial compressed data set, the controller further configured to decompress the initial compressed data set concurrently with the compression of the updated compressed data set.
